(19) United States
(12) Patent Application Publication
(10) Pub. No.: US 2007/0217478 A1
(43) Pub. Date: Sep. 20, 2007

(54) MEASURING DEVICE

(76) Inventors: Anders Carlsson, Linkoping (SE); Ulf Glendor, Linkoping (SE); Anita Jernberg, Norrkoping (SE); Billy Nilsson, Mjolby (SE); Joakim Wren, Linkoping (SE)

Correspondence Address: HAYES SOLOWAY P.C., 3450 E. SUNRISE DRIVE, SUITE 140, TUCSON, AZ, 85718, US

(21) Appl. No.: 11/569,246

(22) PCT Filed: May 16, 2005
(86) PCT No.: PCT/SE05/00703

§ 371 Date: Nov. 16, 2006

(30) Foreign Application Priority Data
May 17, 2004 (SE) 0401269-6

(51) Int. Cl. G01K 11/00

(52) U.S. Cl. 374/162

(57) ABSTRACT

A device for measuring or visualizing temperature distribution along a line or an area, said device comprising areas of relatively good heat conducting or heat storing properties alternating with heat insulating or poorly heat storing areas, so that when the device is brought in contact with an object to be measured more heat energy is transferred to the heat absorbing or heat storing areas than to the heat insulating areas so that heat equalizing does not take place between the heat conducting or heat storing areas for a time, whereupon the temperature remains stable for a time.

The present invention is related to a device for measuring and illustrating temperature and temperature conditions. In many cases one do not only wish to measure temperature in certain points but one wants a temperature profile over a length, area or a volume. Temperature variations can in technical situations give rise to or depend on tensions and or thermal local overload with resulting corrosion, decomposition or more rapid wear. For instance it may be interesting to measure the temperature distribution in car tires since the temperature on the one hand can forebode punctures or unnatural wear and on the other hand indicate wrong settings.

Also in medical situations it may be desirable with temperature measurements and visualizing of these in order to facilitate or enable diagnose by indication of different states of illness. For instance local temperature deviations deviating from the normal may be caused by tumors, fractures, frostbites, burn injuries, tissue changes and other causes respectively resulting circulation disorders. Although thermography thus ought to be a good diagnose aid it is too seldom used. Required equipments have up till now been too expensive and cumbersome and require specialist competence to handle.

In view of the above problem the object of the invention is to provide a device that facilitates measurements of temperature and temperature conditions in different situations and in particular in locations that are difficult to access.

In accordance with the invention the above object is solved by an arranging of relatively heat conductive and/or heat storing areas or bodies alternating with heat insulating and/or poorly heat storing areas. One can also consider to use materials with anisotropic heat conductive ability in order to achieve similar function with principally good heat transport along at least one axis and less conductivity along other axes.

The device can be brought in contact with the object that is to be measured and in a first version of the invention heat energy is transferred to the heat storing areas of the device, while the heat insulating areas does not receive any heat energy, or in any case essentially less thermal energy and furthermore reduce the heat equalizing between the areas or bodies with good ability to store thermal energy. After a short while the heat storing areas have achieved a temperature corresponding to the measured temperature and the device can if required or advantageous be moved for temperature measuring, reading, recording or other evaluation. Since the heat is stored and the drain to the surrounding for each area is restricted the temperature remains stable during a comparatively long time. The recording of the temperature picture stored in this way may take place at the surface that has been in contact with the measured object. For instance a heat camera can be used to photograph the same area of the device that has been in contact with the measured object. One can also advantageously consider to use a thermochromatic coating, film or substance admixture, in particular in or at the heat storing areas. Since the temperature transferred from the measured object remains there is plenty of time either to transfer the temperature picture to a camera or to study the picture directly if the heat storing areas are covered with photochromatic material. In the case of photochromatic material on the heat storing areas the recording or documentation may even be carried out with a digital camera, which provides a considerable cost reduction compared with a heat camera.

An additional advantage is obtained with the invention, namely that the temperature within each continuous heat storing area is equalized within this. At recording, independent of how this is carried out, an increased contrast effect is achieved facilitating the interpretation or treatment of the heat picture.

The invention could also be described as a temperature memory.

In a second version of the invention instead of heat storing also thermal conduction is used to transfer heat through the device for measuring, recording or visualizing on the opposite side of the actual measure surface. In this way also a heat distribution picture is obtained that is turned the right way around.

Frequently one is not only interested in the temperatures on the surface of an object in itself, as for instance in the case of tires or feet, but also of the conditions further inside the measured object. Since the temperature that a heat storing area or body get is a function of i.a. temperature, contact time, heat content and heat conductivity in the measured object one can by increasing the local heat storing capacity in the measuring device, and measuring for a somewhat longer time, get a measure of the thermal conditions depthwise in the measured object.

In a further development of the measuring in depth as above one can consider to arrange areas with differently good heat storing ability close to each other in a repeated pattern. By an appropriate choice of exposure time the different areas receive different temperatures from which the heat content in depth can be evaluated.

In order to adapt the measuring to different situations one can in addition to varying the contact time also vary the initial temperature of the measuring device, up as well as down. If one measure with warmer as well as with a colder measuring device not only a measure of the present heat content is obtained, but also available storing capacity.

Further characteristics, advantages and areas of use are apparent from the following described embodiments, of which some are also illustrated in the enclosed drawings.

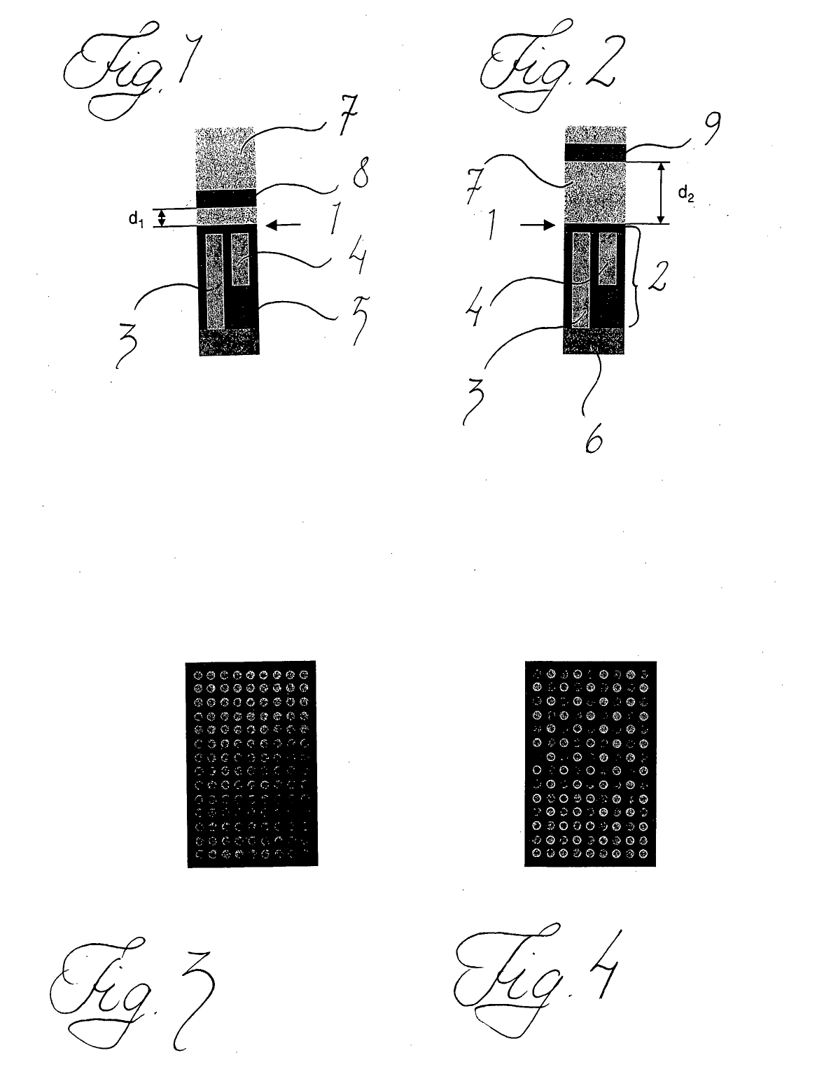

In the drawings FIGS. 1 and 2 show two different objects for measuring with local temperature increase at different depths with a measuring device according to the invention and FIGS. 3 and 4 show different “measure pictures” with the invented device in FIGS. 1 and 2.

Of particular interest is to carry out thermographical analysis of the soles of the feet of diabetics. Many are affected by diabetes and the spreading of the disease increase and is expected to continue to increase in the future. As a result of the sickness the affected may in particular in the feet get circulation disorders and/or loss of sensibility (neuropathy) which phenomena each or together frequently result in inconveniences for instance in the form of inflammations and ulcerations. The circulation disorders may lead to impaired healing and in a regretfully large number of cases to amputation. Impaired sensibility also makes it difficult for or impossible for the affected to discover that everything is not all right with for instance a foot, whether the cause is a circulation disorder or something else. For the diabetics it is thus important that the feet are checked frequently. This is however today with the high workload of the care sector either unrealistic or burdensome since the methods that today are available for checking of foot status, for instance magnetic resonance tomography, heat camera, monofilament sensor test or tuning fork test, are expensive and/or ceremonious to use. Most of the today used methods lack or have a limited ability to register problems of the kind that result from loss of sensibility and/or circulation disturbances.

The above problem is in accordance with a first embodiment of the invention solved with a measuring device including a thermochromatic layer, that is, a layer the color of which vary with the temperature. This layer is arranged parallel to and in contact with, or in some other way thermally communicating with, a heat storing layer that is divided into part areas with intermediate insulation. Advantageously these part areas are made small. The result of the heat storing layer together with the thermochromatic layer is that the temperature remains stable in the measuring device for a comparatively long time before the discrete portions in the heat storing layer emit their heat to each other and to the remaining surrounding respectfully.

For instance the thermochromatic layer may be located on top with the heat storing layer split up in separate elements below this. When a patient place his or her foot on the device both the thermochromatic layer and the underlying heat storing layer are heated to temperatures that vary as a function of the temperature of the foot varying over the surface. When the patient steps off the device heat is no longer supplied but the heat content in the heat storing layer provides a delayed subsiding of the temperature of the thermochromatic layer. The color picture corresponding to the temperature distribution of the foot remains in this way sufficiently long time for a doctor or other competent person to have time to study the result and it is also possible to document the result by for instance photographing the heat picture of the foot. Photographs may be saved in the case book whether this is in paper form or digital. In particular in the latter case it is also possible with digital evaluation that can be compared with how the heat distribution should have been, respectively how it has changed from a previous occasion.

When the foot has been removed from the measuring device an equalizing of the temperature takes place in each separate heat storing part area over this. The accompanying thermochromatic layer part will in this way get the same color over all of its area and in this way one obtain a more clear picture with better contrast, that also is more easily digitalized since it is divided into small defined areas each with a unitary color.

The heat storing layer according to the invention allows not only a measuring of the surface temperature of for instance a foot but can also be used to record heat conditions, that in turn correspond to among other things tissue conditions further inside the foot. This is achieved by giving the heat storing layer a sufficient heat storing capacity to chill or heat the foot to a larger or smaller degree. For instance the heat storing layer can be made thicker. The result is now rather a heat content measuring of the foot, this since heat is transported from the interior of the foot out towards its surface and over into the heat storing layer. Thus if there is a circulation impeding or other heat content and/or heat transport influencing damage a distance inside the foot this is detected with the invention far better than just a reading of the outer temperature by means of a heat camera or other device can provide.

How deep one want to extend ones detection area can be controlled partly by the thickness of the temperature storing layer, partly by the starting temperature of the measuring device and partly the measure time, that is the contact time. By varying these parameters information can be obtained that extend differently far into the foot. Since these parameters comparatively simply can be kept the same at measurements, at different occasions and for different persons respectively, objective and regularized observations can be made with the adherant improved diagnostic and treatment possibilities.

Since the device according to the invention becomes comparatively simple and inexpensive to fabricate and use the number of examination occasions can increase essentially and therewith increase the chances to discover changes and damages in good time, so that these may be treated before becoming too serious. One can even imagine that every diabetic has his own foot status gauge at home. This makes it easier to prescribe preventive measures since the patient may be given an immediate feedback.

The heat storing or heat absorbing layer that is divided into discrete areas or units with intermediate insulation can be made in different ways. For instance one can conceive aluminum rods that are pushed down into holes in a dic of foam plastic. One can also conceive the insulation matrix being of a suitable ceramics with a good insulating capacity in the holes of which a suitable metal can be cast or filled, thereafter to be ground so that a flat surface is obtained.

The heat storing or heat absorbing layer can also be constituted by thin fibers or rods that extend between two fixing films. At this the material between the fibers may be air or an insulating gas. One can also conceive a thermochromatic material with advantageous heat conducting and/or heat storing properties, in finely divided or liquid form, and being placed in cavities in an insulator.

By providing the heat storing or heat transporting bodies with domed surfaces the heat transfer is improved, partly through an increased area, partly by the contact between measured object for instance a foot and the measuring device, only exist for the heat storing bodies.

The heat storing from each other thermally insulated bodies may constitute axially moveable pins that by gravity or spring influence each or in groups are brought in contact with the heat object even if this has a complicated structure. In this way the risk of erroneous measurements due to inadequate contact is reduced.

Even if one primarily imagine the heat transfer taking place through contact with the measured object, one can consider to use heat emitted in the form of radiation for measuring, in particular at measured objects that in themselves are too hot for direct contact.

One can also conceive the heat storing or insulated areas or discrete bodies containing or comprising materials that through adding or removal of heat energy is transformed between different phases or chemical forms, which increase the accumulation ability and also makes it possible to obtain threshold values for the temperatures.

The thermochromatic layer may be arranged on the upper side of the heat absorbing layer, so that in for instance the case with feet measuring the patient quite simply get up on the measuring device, stands there a prescribed time and step down, whereafter the thermochromatic layer is inspected and or photographed. In order to avoid temperature equalizing in the surface one can also consider to split up the thermochromatic layer corresponding to the discrete heat absorbing elements in the heat insulating layer.

If so desired one may instead arrange the thermochromatic layer on the bottom side of the heat absorbing layer. in this way the heat transfer from a measured object, for instance a foot, to the heat absorbing layer may be improved shortening the actual test time. During the time one then turns the device in order to view the temperature picture, the picture stabilizes when the heat is evened out separately in each distinct element.

If one desire a mechanically more flexible temperature sensing device in accordance with the invention one can conceive an arranging of small metal rivets in an elastic material, for instance rubber cloth, with a thermochromatic layer on one side of the rivets.

Instead of using thermochromatic film one can instead consider the use of a heat camera for photographing of the heat storing layer. Alternatively each separate section can be provided with electronic temperature sensing. By arranging this on top and continuously register the temperature change when the heat storing layers draw thermal energy it is possible to gain further information of the heat content in the depth direction, that is a 3D information of the heat content. Probably however these version are less advantageous from a practical point of view in most cases in comparison with the use of thermochromatic film.

In the above way the invention may be used as a load test for the heat supply to a body part, for instance a foot. Since a major part of the heating in a foot is supplied in the form of heated blood a good measure of the circulation can be obtained in this way.

Within the scope of the invention one can consider to use materials that are anisotropic in a suitable way, that is allow transport and storage of heat in through the layer, while the spreading in the surface plane (or more or less in parallel with this) is slight. For instance one can consider that such materials may be achieved by means of substances that have a tendency to form elongate parallel molecules.

A further embodiment of the invention is shown in FIG. 1. Here the device comprise a top layer 1 that is thermochromatic, a layer 2 present below this containing discrete heat transporting and heat storing rods 3, 4 that are insulated from each other by an intermediate heat insulation 5. On the bottom side of the heat absorbing layer 2 a lower supporting heat insulating layer 6 is arranged.

On top of the measuring device a foot 7 is placed and in this is in FIG. 1 shown a first position of a section 8 with increased heat content. In FIG. 2 another section 9 with increased temperature is shown that is located higher up.

The rods 3 an 4 have different lengths and can thereby store different amounts of heat. At equal supplied amounts of heat the longer rod will achieve a lower temperature. This can for instance be achieved with an exposure time that is fairly short, so that temperature equalizing does not take place between foot and measuring layer.

In FIG. 3 is shown an area with the same temperature for all the rods, that is with the same color for measure points. This case can for instance correspond to the one shown in FIG. 1. Since the distance from the area with increased temperature is short sufficient heat energy will have time to be transferred to result in the same temperature for both type of rods.

In FIG. 4 is shown an area where the time has been so short that the long rods have not had time to achieve the same temperature as the short rods. Here the distance to the area with increased temperature may have been longer, as in FIG. 2, so that the heat that has flown from the area with increased temperature to the rods have not had time to arrive in sufficient amount to result in the same color. The larger color difference (temperature difference) that exist between adjacent rods with different length the longer the distance to the area with increased temperature is, at a given exposure time.

By means of the device shown in the drawings it is thus possible to visualize the heat distribution in depth. Since feet to some part are comparatively flat one can also conduct a similar measurement from the upper side in order obtain increased knowledge of the heat conditions in the entire cross section.

Instead of a thermochromatic layer one can use another temperature visualizing layer for instance swelling paper.

If the heat absorption and insulation respectively are sufficiently efficient one can consider not to apply the thermochromatic layer until the patient has removed his foot from the heat absorbing layer. When the thermochromatic layer then is applied the absorbing layer emits heat to thermochromatic layer resulting in a color picture corresponding to the heat content in the foot and in that way the circulation.

At the use of the device in accordance with the invention to transfer a temperature or heat content sample from a location that is difficult to access to a suitable measuring means the latter may not only be constituted by thermochromatic film or a heat camera but it is furthermore possible to consider the use of a magnet resonance tomograph in order even more clearly to extract depth information from the heat storing material and in this way also for the measured object.

The principle of the invention can also be made use of in the form of a rod that is coated with thermochromatic material in its length direction, or a glass tub filled with a mixture of see through gel and a thermochromatic material so that a temperature profile in the length direction of the rod can be made visible in a simple way, corresponding in turn to a heat amount profile of the measured object.

In order to enable rapid sampling with a device in accordance with the invention it is suggested that this is brought in contact, over its entire surface, with for instance a metal plate of room temperature, alternatively metal plate so that the heat content in the separate heat storing elements is drained off and an even, well defined temperature is obtained.

As an alternative to study the heat emission from an object or a body instead the temperature memory according to the invention may first be heated then to be brought in contact with the object or body in order to register how quickly heat is drained locally.

1-16. (canceled)

17: A device for measuring or visualizing temperature distribution along a line or an area, said device comprising areas of relatively good heat conducting or heat storing properties alternating with heat insulating or poorly heat storing areas, so that when the device is brought in contact with an object to be measured more heat energy is transferred to the heat absorbing or heat storing areas than to the heat insulating areas so that heat equalizing does not take place between the heat conducting or heat storing areas for a time, whereupon the temperature remains stable for a time.

18: The device of claim 17, which comprises an anisotropic material having different heat conductions in different directions.

19: The device of claim 17, which comprises an insulating material enclosing bodies of heat storing and/or heat conductive material, separated from each other by insulating material.

20: The device of claim 17, which comprises separate parts or bodies of heat storing or heat conducting material forming an area that directly or indirectly can be brought in contact with the object being measured.

21: The device of claim 17, wherein a temperature registrating layer, film or mixture is arranged in contact with or mixed with the heat storing material, and possibly divided as this, either on the side that faces the object being measured or faces away from the object being measured.

22: The device of claim 19, wherein the temperature registration layer is thermochromatic.

23: The device of claim 19, wherein neighboring separate bodies or parts have areas of the same size facing the object being measured but having different heat capacity, for instance different volume, density or material in order to receive at short exposure different final temperatures at different distances to a heat source in the measured object.

24: A method for thermographic measuring with a device as claimed in claim 17, comprising the step of chilling or heating the device before use.

25: The method of claim 24, wherein the device is only brought in contact with an object being measured during a short time so that temperatures do not have time to be equalized between the object being measured and the measuring device whereupon transient conditions exist.

26: The method of claim 24, wherein the measuring is carried out with different initial temperatures of the measuring device and/or with differently heat absorbing layers and/or with different measuring times.

27: A method for temperature measuring in depth, wherein a measuring point, measuring line or measuring area of a body in a shape of a rod that is coated with thermochromatic material in its length direction, or a glass tube filled with a mixture of see through gel and thermochromatic material, is applied so that a temperature profile in a length direction of the rod can be visualized simply, corresponding in turn to a heat amount profile of the object being measured.

28: The device of claim 17, wherein the areas or bodies each have a convex surface.

29: A device for measuring and registration of temperature of an object which comprises heat storing elements that are separated by heat insulating material so that the device in contact with a body or object being measured is heated as a function of the temperature of each part area in contact directly or indirectly with an element.

30: The device of claim 29, wherein each element in one end is coated with a thermochromatic material or layer.

31: The device of claim 30, wherein the thermochromatic layer is arranged in an end of the elements that at measuring is in contact with the object or body being measured.

32: A method for measuring thermal conditions along a line, over an area or in a body or volume, comprising elements, that can store heat, arranged side by side with intermediate insulation are brought in contact with a sufficiently long time for heat to be transferred to the separate elements of the device as a function of the thermal conditions in the measured object, and when this has taken place the device is removed from the measured object for evaluation, at which the heat storing elements retain their temperature for a time during which registration or evaluation can take place.
